(19) United States
(12) Patent Application Publication
(10) Pub. No.: US 2021/0116390 A1
(43) Pub. Date: Apr. 22, 2021

(54) EXTENDED INFRARED SPECTROSCOPIC WAFER CHARACTERIZATION METROLOGY

(71) Applicant: University of North Texas, Denton, TX (US)

(72) Inventors: Jin-Jian Chen, Denton, TX (US); Oliver Ming-Ren Chyan, Denton, TX (US)

(21) Appl. No.: 17/073,601

(22) Filed: Oct. 19, 2020

Related U.S. Application Data
(60) Provisional application No. 62/923,361, filed on Oct. 18, 2019.

(51) Int. Cl. G01N 21/95; G01N 21/27; G01N 21/3563

(52) U.S. Cl. CPC G01N 21/9501; G01N 21/3563; G01N 21/27

(57) ABSTRACT

The present disclosure provides an extended spectroscopic wafer characterization metrology that provides highly sensitive chemical bonding transformation information in the extended mid-IR region (e.g., 1 μm-25 μm). The extended spectroscopic metrology described herein utilizes both total internal reflection and transmission infrared spectroscopy with angle dependent spectroscopic acquisition to optimize high detection sensitivity for the measurement of fundamental chemical bonding vibrations and associated rotational-vibrational structure for fabricated film stacks and nanostructures on a wafer substrate that has been polished on the both sides.

### CROSS-REFERENCE TO RELATED APPLICATION

The present application claims priority to U.S. Provisional Patent Application No. 62/923,361 filed Oct. 18, 2019 and entitled “EXTENDED INFRARED SPECTROSCOPIC WAFER CHARACTERIZATION METROLOGY,” and is related to U.S. patent application Ser. No. 13/420,686 filed Mar. 15, 2012 and entitled “WAFER FABRICATION MONITORING/CONTROL SYSTEM AND METHOD,” issued Jun. 14, 2016 as U.S. Pat. No. 9,366,601, the disclosures of which are incorporated by reference herein in their entirety.

### TECHNICAL FIELD

The present disclosure generally relates to silicon wafer fabrication and more particularly to techniques for analyzing, monitoring, and characterizing manufactured silicon wafers.

### BACKGROUND

By providing the ability to monitor and detect defects at each stage of advanced integrated circuits (IC) processing, semiconductor metrology plays an important role in improving yield, reducing manufacturing costs, and shortening the product development cycle. As transistor feature sizes become smaller than 5 nanometers (nm), manufacturable microfabrication processes require full integration of new materials development, effective patterning processing of nanostructures, and equally important, sensitive metrology tools to monitor, control, and optimize the processing flow. The increasingly stringent critical dimension (CD) control needed for <5 nm IC devices demands a sub-nm (e.g., <±0.2 nm) CD variance control. One nanometer (10⁻⁹ m) can accommodate approximately seven carbon atoms. As such, current targeted vigorous sub-nm CD control for advanced microelectronic fabrication demands unprecedented control of chemical bonding formation and breaking at specific time sequences and within tightly controlled nanometer spaces. Given these technological challenges, it is imperative to have a sensitive wafer characterization metrology that is capable of providing chemical bonding transformation insights for each processing step during the systematic development of microelectronic fabrication processing.

As shown in FIGS. 1 and 2, current wafer characterization tools can provide useful information on the cross-sectional profile, elemental composition, physical dimensions, and crystal structure of a fabricated nanostructure. It is noted that surface features 102 of silicon wafer 104 (shown in FIG. 1) are exaggerated in size relative to the thickness of the silicon wafer 104. The characterization tool illustrated in FIG. 2 shows a semiconductor metrology approach that utilizes Multiple Internal Reflection Infrared Spectroscopy (MIR-IR) and associated IR techniques to probe intricate chemical bonding transformations taking place across microfabrication processing steps and is described in more detail in U.S. Pat. No. 9,366,601, the contents of which are expressly incorporated herein by reference. The super MIR-IR detection sensitivity (e.g., <10% monolayer) has greatly accelerated the research and development progress in both the front end and the back end of line processing flows, including cleaning of fluorocarbon etch residues, minimizing porous low-k dielectric, plasma-enhanced chemical vapor deposition (PECVD), atomic layer deposited thin films, plasma induced reactive ion etching, flowable dielectrics, silicon nitride selective etching, ultraviolet (UV) curing, post-etch cleaning, and the like. New insights on the chemical bonding modification across critical interfaces obtained from such tools have greatly aided in the research and development of new microfabrication processing for sub-5 nm transistor devices. However, current process monitoring methods do not yield chemical bonding information that enables accurate evaluation of the chemical bonding integrity at critical interfaces, chemical structure of deposited ultra-thin film, and how that may affect the integration compatibility of one or more subsequent processing steps.

### SUMMARY

The present disclosure provides an extended infrared spectroscopic wafer characterization metrology that provides highly sensitive chemical bonding transformation information in the extended mid-IR region (e.g., 1-25 μm). The extended spectroscopic metrology described herein utilizes both total internal reflection and transmission infrared spectroscopy with angle dependent spectroscopic acquisition to optimize high detection sensitivity for the measurement of fundamental chemical bonding vibrations and associated rotational-vibrational structure for fabricated film stacks and nanostructures on a wafer substrate that has been polished on the both sides.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 illustrates conventional characterization tools to assist nanostructure fabrication on silicon wafer substrate.

FIG. 2 illustrates the wafer characterization method utilizing Multiple Internal Reflection Infrared Spectroscopy (MIR-IR) for sensitive chemical bonding characterization for thin film patterned nanostructure fabricated on wafer surface.

FIG. 3 shows an extended spectroscopic wafer characterization metrology that utilizes both internal refection and transmission spectroscopy with the detection sensitivity optimization using the angle dependent spectroscopic acquisition.

FIG. 4 is a plot illustrating the transmission spectrum of silicon.

FIG. 5 is a plot illustrating the transmission spectrum of germanium.

FIG. 6 is a plot illustrating the transmission spectrum of gallium arsenide.

FIG. 7 show the loss of infrared signals below 1500 cm⁻¹ of a thin dielectric film deposited on a silicon wafer substrate measured by multiple internal reflection infrared spectroscopy.

FIG. 8 illustrates various ways, in addition to FIG. 2, to introduce IR probe beam for sensitive wafer characterization 1) by a bevel face 2) single face signal coupler 3) multi-facet signal coupler.

FIG. 9 is a plot illustrating an extended spectroscopic wafer characterization metrology that restores infrared signals below 1500 cm⁻¹ of thin dielectric film deposited on a silicon wafer substrate.

FIG. 10 illustrates how new extended spectroscopic wafer characterization metrology can be adapted to automatic full wafer characterization.

FIG. 11 is a block diagram of a system for performing an extended spectroscopic wafer characterization metrology in accordance with aspects of the present disclosure.

FIG. 12 is a flow diagram of an exemplary method for performing an extended spectroscopic wafer characterization metrology in accordance with aspects of the present disclosure.

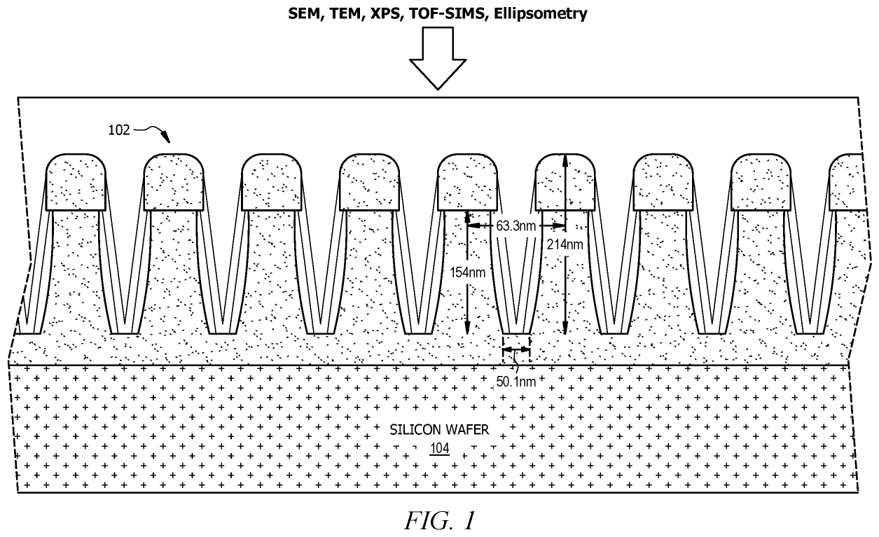

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

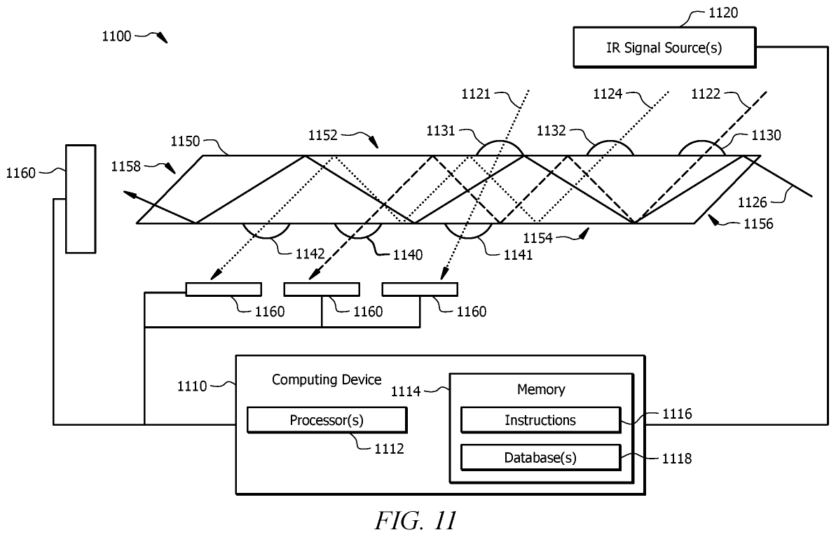

Referring to FIG. 11, a block diagram illustrating a system for performing MIR-IR spectroscopy in accordance with aspects of the present disclosure is shown as a system 1100. As shown in FIG. 11, the system may include a computing device 1110, an IR signal source 1120, and one or more detectors 1160. The computing device 1110 includes one or more processors 1112 and a memory 1114. The memory 1114 may store instructions 1116 that, when executed by the one or more processors 1112, cause the one or more processors 1112 to perform operations for performing MIR-IR spectroscopy in accordance with the present disclosure, as described in more detail below. One or more databases 1118 may be stored at the memory 1114. The one or more databases 1118 may store information associated with results obtained from MIR-IR spectroscopy operations and other types of information, as described in more detail below.

As shown in FIG. 11, the computing device 1110 may be communicatively coupled to the IR signal source 1120 and the one or more detectors 1160. The connection between the computing device 1110 and the IR signal source 1120, as well as the connection between the computing device 1110 and the one or more detectors 1160, may be provided via one or more wired or wireless communication links. Such communication links may include Ethernet communication links, serial communication links, Universal Serial Bus communication links, Wi-Fi communication links, or other types of communication links. One or more of the communication links may be established according to one or more network communication protocols or standards.

The computing device 1110 may be configured to control the IR signal source 1120 during MIR-IR spectroscopy operations. For example, the computing device 1110 may control the IR signal source to irradiate a wafer 1150 with an IR signal 1122. The wafer 1150 may be a patterned wafer having a mirror finish on its upper surface 1152 and its lower surface 1154. The IR signal 1122 may not be capable of penetrating the wafer 1150 due to the total reflection by mirror finish surface. In accordance with the present disclosure, an input signal coupler 1130 may be provided. The input signal coupler 1130 may be formed of a same or similar material to the wafer 1150, by the direct physical contact of coupler 1130 to the wafer 1150, thereby to enabling the IR signal 1122 to penetrate the mirror finish of the wafer 1150. To facilitate MIR-IR spectroscopy, the IR signal 1122 may be transmitted to the input coupler 1130 at an angle, thereby allowing the IR signal 1122 to penetrate the wafer 1150. In an aspect, the angle at which the IR signal source 1120 provides an IR signal(s) to the wafer 1150 may be controlled using one or more mirrors (not shown in FIG. 11). Since the IR signal 1122 is provided at an angle, the mirror finish of the wafer 1150 may act as a waveguide and the IR signal 1122 may propagate through the wafer 1150 via multiple internal reflections. Radiation associated with the IR signal 1122 may be detected by a detector 1160. As shown in FIG. 11, the radiation associated with the IR signal 1122 may exit the wafer 1150 at an output signal coupler 1140. The output signal coupler 1140 may be formed of a same or similar material to the wafer 1150, by the direct physical contact of coupler 1140 to the wafer 1150, thereby to enabling the radiation associated with the IR signal 1122 to exit the wafer 1150 and be detected by the detector 1160. It is noted that although FIG. 11 illustrates the input signal coupler 1130 and the output signal coupler 1140 as being disposed on opposite surfaces of the wafer 1150 (e.g., top surface 1152 and bottom surface 1154), it is to be understood that signal couplers according to the present disclosure may be disposed on the same side (e.g., both on the top surface 1152 or both on the bottom surface 1154). Additionally, where multiple input signal couplers and multiple output signal couplers are utilized, as described in more detail below, one or more of the input/output signal couplers may be disposed on the same side/surface of the wafer 1150 or different sides/surface, or even have some input/output signal couplers on a single side while one or more signal couplers are on a different side.

As the detector 1160 detects the radiation corresponding to the IR signal 1122, information associated with the detected radiation may be provided to the computing device 1114. The one or more processors 1112 may be configured to generate a spectrum based on the radiation detected by the one or more detectors 1160. In an aspect, the information associated with the radiation may be stored at the one or more databases 1118 and the one or more processors 1112 may be configured to generate the spectrum after IR interrogation of the wafer 1150 is complete. The one or more processors 1112 may be configured to characterize the wafer 1150 based on the spectrum. In an aspect, characterization of the wafer 1150 may include determining one or more characteristics of the wafer 1150. For example, characteristics that may be determined based on the spectrum derived from the radiation corresponding to the IR signal 1122 may include chemical bonding information that previous techniques do not provide. Such information enables accurate evaluation of the chemical bonding integrity at critical interfaces, chemical structure of deposited ultra-thin films, and how such characteristics may affect the integration compatibility of one or more subsequent processing steps. Due to its proven highly sensitive sub-monolayer detection capacity from a patterned silicon wafer, the extended wafer characterization metrology disclosed herein can provide critical chemical bonding transformation insights to optimize microelectronic fabrication process evolution, shorten research and development cycles and lower manufacturing costs.

It is noted that although the exemplary process illustrated above has been described as utilizing a single IR signal (e.g., the IR signal 1122), embodiments may utilize more than one IR signal. For example, in FIG. 11, a second IR signal 1124 is shown. The IR signal 1124 may be provided to a second signal coupler 1132 by the IR signal source 1120 based on control information provided by the one or more processors 1112. The second signal coupler 1132 may also be formed of the same or a similar material to the wafer 1150. Similar to the IR signal 1122, the IR signal 1124 enter the wafer 1150 at an angle via the signal coupler 1132 and may propagate through the wafer 1150. As the IR signal 1124 propagates through the wafer 1150, the IR signal 1124 may experience multiple internal reflections (e.g., due to the mirror finish of the wafer 1150 acting as a waveguide) and radiation corresponding to the IR signal 1124 may exit the wafer 1150 via a second output signal coupler 1142. As the IR signal 1124 exits the output signal coupler 1142, radiation corresponding to the IR signal 1124 may be detected by the detector 1160. It is noted that the radiation associated with the IR signal 1124 may be detected by the same detector or a different detector that detects the radiation corresponding to the IR signal 1122. The radiation corresponding to the IR signal 1124 may be utilized to generate the spectrum from which the one or more characteristics of the wafer 1150 are derived. In an aspect, the spectrum for the radiation corresponding to the IR signal 1124 may be generated separate from the spectrum for the radiation corresponding to the IR signal 1122. Alternatively or additionally, a single spectrum may be generated based on both the radiation corresponding to the IR signal 1124 and the radiation corresponding to the IR signal 1122. Additionally, information associated with the radiation detected for the IR signal 1124 may be stored at the one or more databases 1118. It is noted that where multiple IR signals are utilized, one or more IR signal sources may be provided. For example, a first IR signal source may generate the IR signal 1122 and a second IR signal source may generate the IR signal 1124, or a single IR signal source may generate both the IR signal 1122 and the IR signal 1124. Further, it is noted that where multiple IR signal sources are used, the IR signal sources may be configured to provide the IR signals to the respective input signal couplers at the same or different angles. Additional examples of other IR signals that may be utilized to characterize a wafer according to aspects of the present disclosure are described in more detail below.

It should be understood that while the exemplary process illustrated above has been described as utilizing one or multiple IR signal sources (e.g., the IR signals 1122 and 1124) operated in a multiple internal reflection detection mode, embodiments may additionally utilize one or multiple IR signal sources to operate in the transmission detection mode. For example, in FIG. 11, another IR signal 1121 is shown. It is noted that although FIG. 11 illustrates the IR signal 1121 being provided with a signal coupler 1131 by the IR signal source 1120 based on control information provided by the one or more processors 1112, in some embodiments the IR signal 1121 may be provided and utilized in a transmission detection mode only without a signal coupler. The signal coupler 1131, when present, may be formed of the same or a similar material to the wafer 1150. Similar to the IR signals 1122 and 1124, the IR signal 1121 enters the wafer 1150 at an angle through a signal coupler 1131, and may transmit through the wafer 1150. As the IR signal 1121 transmits through the wafer 1150, the radiation corresponding to IR signal interacts with thin films deposited on wafer 1150 and may exit the wafer 1150 via an output signal coupler 1141. As the IR signal 1121 exits the output signal coupler 1141, radiation corresponding to the IR signal 1121 may be detected by the detector 1160. It is noted that the radiation associated with the IR signal 1121 may be detected by the same detector or a different detector that detects the radiation corresponding to the IR signals 1122 and 1124. The radiation corresponding to the IR signal 1121 may be utilized to generate the spectrum from which the one or more characteristics of the wafer 1150 are derived. In an aspect, the spectrum for the radiation corresponding to the IR signal 1121 may be generated separate from the spectra for the radiation corresponding to the IR signals of 1122 and 1124. Alternatively or additionally, a single spectrum may be generated based on both the radiation corresponding to the IR signal 1121 and the radiation corresponding to the IR signals of 1122 and 1124. Additionally, information associated with the radiation detected for the IR signal 1121 may be stored at the one or more databases 1118.

Although the examples described above illustrate embodiments utilizing a one IR signal, one input signal coupler, and one output signal coupler; or two IR signals, two input signal couplers, and two output signal couplers; or three IR signals, three input signal couplers, and three signal couplers, such description has been provided for purposes of illustration, rather than by way of limitation. Therefore, it is to be understood that embodiments may include more than three IR signals and input/output couplers or less than three IR signals and input/output couplers. Utilizing more than one IR signal and more than one input/output signal coupler pair may provide further advantages, such as enabling the entire wafer to be characterized while realizing reduced signal degradation (e.g., by spacing the input signal couplers at different locations across the wafer or enabling the IR signals to be introduced into the wafer at different angles, directions, etc.), thereby improving the observations and insights provided at a particular phase of wafer processing.

In an additional aspect, the exemplary techniques disclosed herein may also be utilized in conjunction with other techniques for providing MIR-IR spectroscopy, such as the techniques disclosed in U.S. Pat. No. 9,366,601. For example, in FIG. 11, an IR signal 1126 may be used to irradiate an edge surface 1156 of the wafer 1150. The IR signal 1126 may be introduced to the edge surface at an angle resulting in multiple internal reflections that propagate through the wafer and can be detected by a detector 1160 configured to detect radiation emitted from the edge surface 1158 of the wafer 1150. The radiation corresponding to the IR signal 1126 may be utilized to generate a spectrum, either individually or in combination with the radiation corresponding to the IR signal 1122 and/or the IR signal 1124. The determined spectrum may provide further information that may be utilized to characterize the wafer 1150. It is noted that the characteristics derived from the portion of the spectrum associated with the IR signal 1126 may be different from the characteristics derived from the portion of the spectrum associated with the IR signal 1122 and/or the characteristics derived from the portion of the spectrum associated with the IR signal 1124. With multiple accesses of IR probe beams, 1121, 1124, 1133, and 1126, on a targeted wafer sample and angle dependent acquisition, the new wafer measuring techniques disclosed herein allow more sensitive detection capacity and better spectra resolution that enables new and useful chemical bonding insights to be obtained, which is highly desirable for new integrated circuit (IC) fabrication technology development and overall process integration successes.

As shown above, the system 1100 provides new techniques for performing infrared spectroscopy, which facilitates analysis of the characteristics of a wafer at different stages of processing. These new techniques provide enhanced characterization and analysis of the wafer, such as enabling chemical bonding information to be obtained, which was not able to be captured using previous approaches. Most importantly, the disclosed metrology can monitor chemical bonding transformation progression with sub-monolayer sensitivity of a few nanometer ultrathin film deposition processes. Therefore, these new wafer characterization techniques can help to better control the nano-fabrication process evolution required by advanced <5 nm IC production. With these new chemical bonding transformation insights and process related information, further improvements in the microfabrication processes and manufacturing technologies for wafer fabrication may be realized, the research and development cycles may be shortened, production yield may be increased, and manufacturing costs may be lowered.

As shown above, the system 1100 provides improved infrared spectroscopy techniques that facilitate the study of interaction between chemical bonding vibrational modes of a targeted sample, such as the wafer 1150, and radiated energy in the IR spectrum. Fourier transform IR (FT-IR) spectroscopy is a technique that measures information across an entire wavelength range simultaneously and then the information may be transformed to provide a spectrum (e.g., the various spectra described above) for the sample under test. The determined spectrum may include various peaks and the position, shape, and intensity of peaks may provide insights into the chemical bonding structure, hence molecular structure of the sample (e.g., the wafer 1150) as well as indicate the presence and, in many cases, the amount of a particular chemical substance in the sample.

As explained with reference to FIG. 11, the extended spectroscopic wafer monitoring systems and methods disclosed herein use a patterned wafer itself as an IR waveguide in place of an external crystal substrate for receiving the IR beam. Since the patterned dielectric films of interest are deposited and formed directly on the wafer surface, a sample-contact problem occurring in other ATR techniques does not impede the sensitive detection of the IR radiation of the presently disclosed measuring system. The systems and methods described herein enable extended spectroscopic wafer characterization ex-situ and in-situ measurements for semiconductor processing. Such systems and methods may be applicable to a wide variety of wafer types, including but not limited to, silicon wafers, germanium wafers, SiGe hybrid wafers, silicon-on-sapphire (SOS) wafers, GaAs wafers, epitaxial Si overlayer on Ge wafers; also including wafers made of KRS-5, ZnSe, ZnS, CdTe, KCl, CsI, KBr, NaCl, BaF2 and Ge—As—Se AMTIR materials, other wafer variants/types utilized to fabricate electronic circuits, and the like. Thus, the term “wafer” should be given its broadest possible meaning to encompass any wafer on which electronic circuits may be patterned and through which an IR source/detector apparatus, such as the IR signal source 1120 and the detector(s) 1160 of FIG. 11, can be positioned to implement the teachings of the present disclosure.

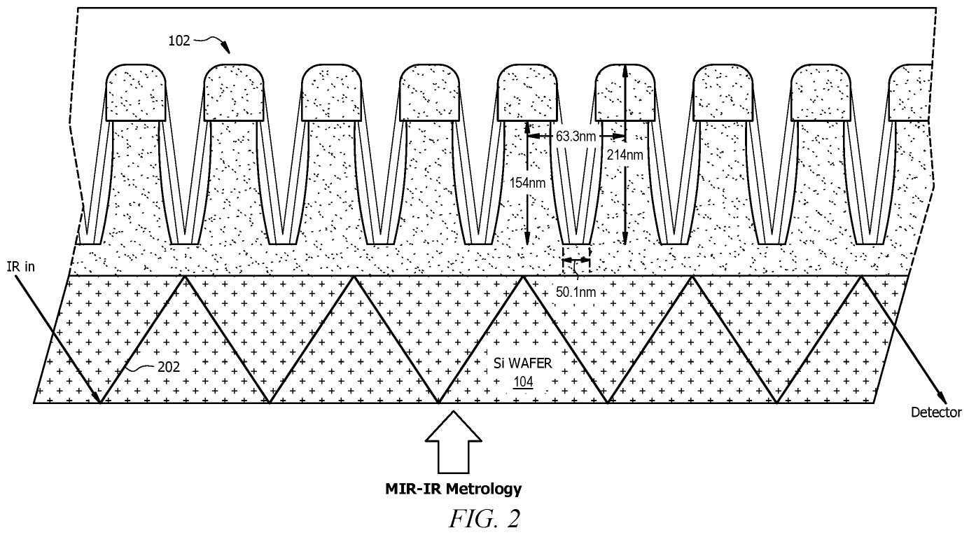

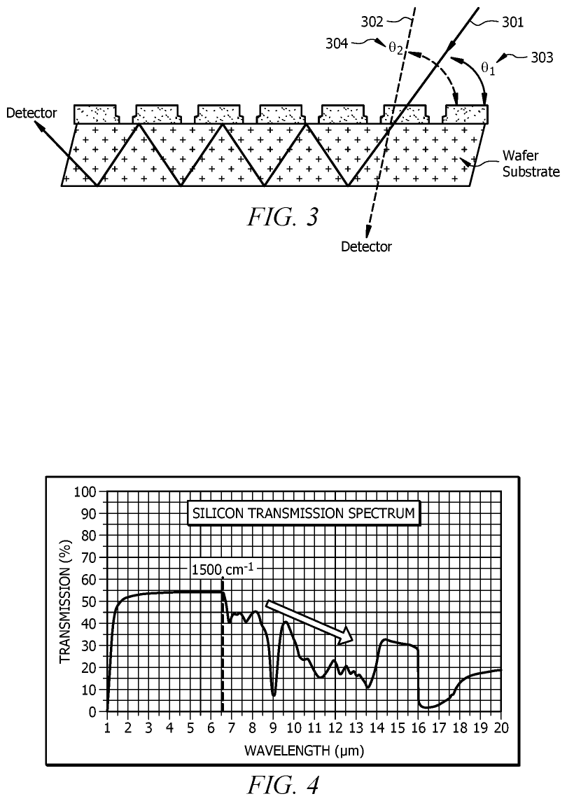

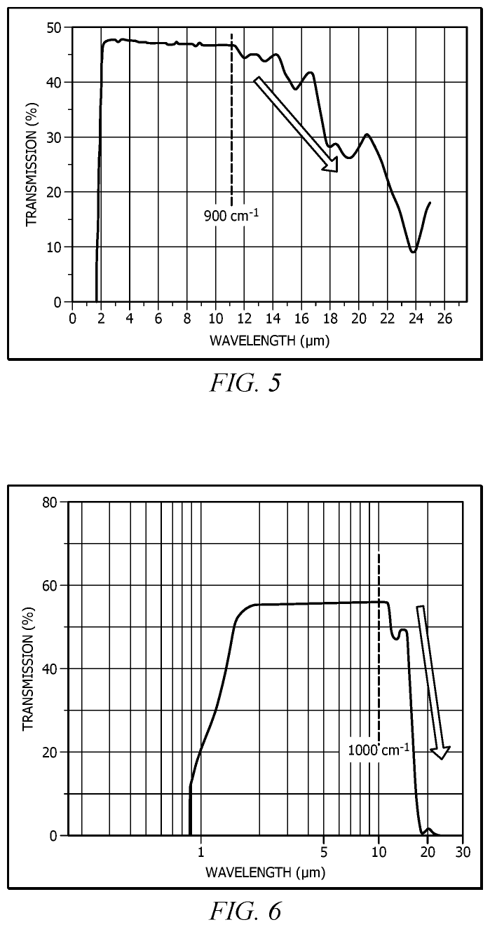

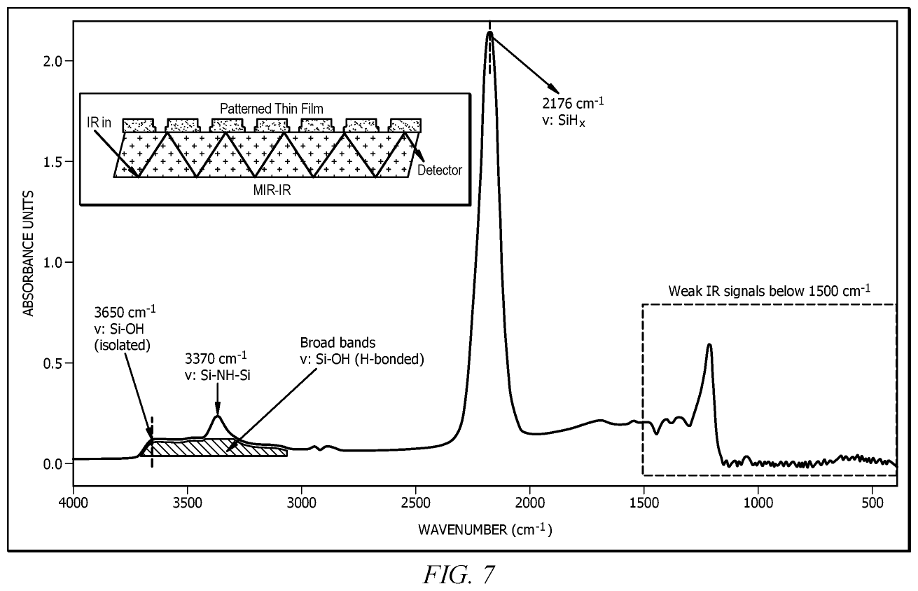

Many of the IR transparent wafer materials gradually become more opaque toward near far-IR regions. For example and referring to FIG. 4, a silicon wafer exhibits decreasing IR transparency past 1500 cm⁻¹ due to phonon adsorption bands originating in the silicon crystal lattice. A similar loss of IR transparency toward near far-IR regions may be observed in germanium wafers (e.g., <900 cm⁻¹), as shown in FIG. 5 and in gallium arsenide wafers (e.g., <1000 cm¹), as shown in FIG. 6. As illustrated in FIG. 2, MIR-IR wafer characterization metrology utilizes multiple internal reflections within an internal reflection element (e.g., the silicon wafer) to increase IR measuring sensitivity by multiple sampling, which improves the signal-to-noise ratio (SNR). However, the multiple internal reflections in a silicon crystal lattice may cause an increasing portion of IR probe beam, especially below 1500 cm⁻¹ for silicon wafer, as shown in FIG. 4, to be strongly absorbed by the Si—Si phonon bands adsorption background. Referring to FIG. 7, a plot showing a MIR-IR spectrum collected from a thin dielectric film deposited on a silicon wafer substrate is shown. As shown in FIG. 7, this enhanced Si—Si phonon background absorption blocks the IR probe beam interacting with targeted thin film sample on silicon wafer and results in low IR sampling signal that precludes the useful analytical application of MIR-IR metrology below 1500 cm⁻¹ on silicon wafers.

The improved infrared spectroscopic wafer characterization processes described above with reference to FIG. 11 overcome the above-mentioned probing difficulties associated with previous MIR-IR metrology approaches, which suffer from the decreasing transparency of absorption background. This improved approach is further illustrated in FIG. 3, which shows an extended spectroscopic wafer characterization approach that utilizes both total internal refection, by IR probe beam of 301, and transmission spectroscopy, by IR probe beam of 302, with the angle dependent spectroscopic acquisition 303 and 304. In FIG. 3, the angle of incidence of the IR signal(s) may be varied by adjusting one or more mirrors in an optical path of an IR probe beam (e.g., one of the IR signals 1121, 1122, 1124 of FIG. 11) incident with respect to the wafer (e.g., the wafer 1150 of FIG. 11) on which thin film structures being analyzed are formed. Through this approach, embodiments are able to achieve complete wafer characterization, including previously unattainable near far-IR regions by MIR-IR metrology alone.

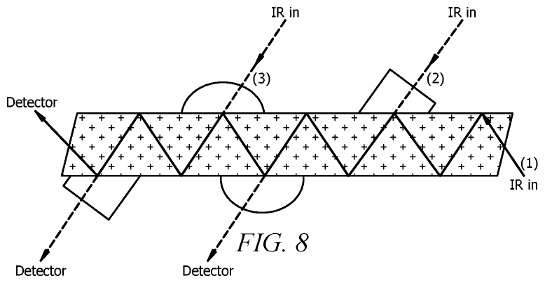

Referring to FIG. 8, the incident IR probe beam on the wafer surface may be adjusted by changing the angle of a beveled edge or adding signal couplers (e.g., the input/output signal couplers 1130, 1131, 1132, 1140, 1141, 1142 of FIG. 11) to guide the IR incidence beam with selected range incident angles. As the IR probe beam is scanned from a near glazing angle toward higher incident angles (e.g., θ₁ and θ₂ of FIG. 3), the proportion of internal reflection and partial transmission of the IR probe beam may vary accordingly. IR detectors may be positioned to detect both internal reflection radiation and transmission radiation during the scanning of IR probe signals with respect to the wafer surface on which various thin film structure being analyzed are formed. The IR detectors may include mercury cadmium telluride (MCT) detectors, triglycine tulphate (DLaTGS) pyroelectric detectors, silicon bolometer detectors, and various other IR detectors depending on the particular configuration of the system.

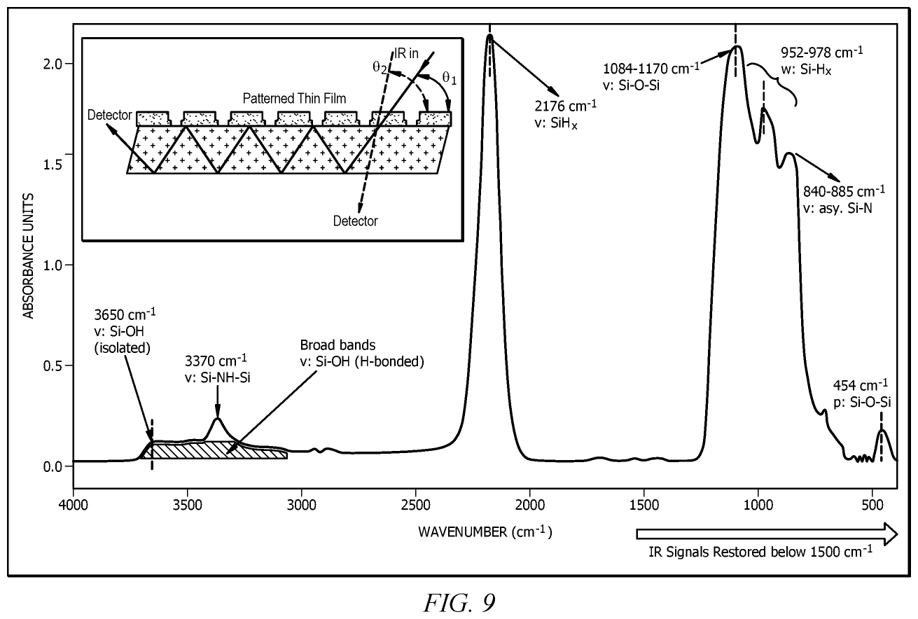

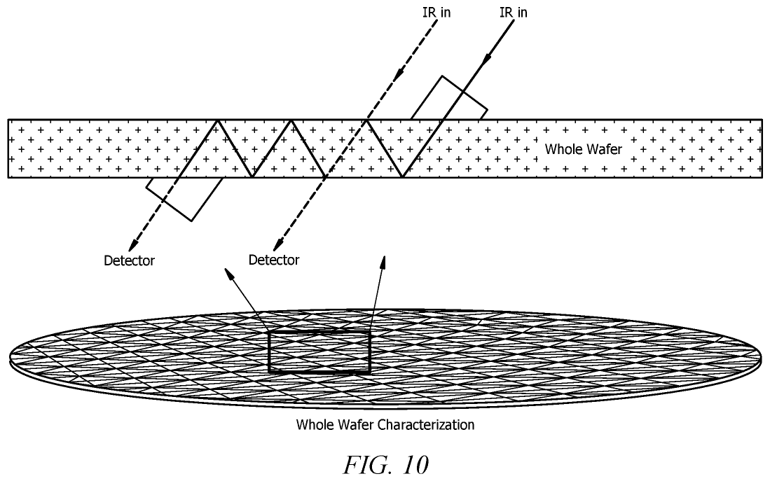

This extended angle-dependent spectroscopic acquisition of both internal reflection radiation and transmission radiation may be carried out concurrently or sequentially during scanning of the IR probe signal(s) at incident angles. Based on the obtained responses from selected IR detectors, the resulting IR absorption peaks (both peak height and peak shape) from the internal reflection characterization mode may be compared with the IR absorption peaks from the transmission mode to obtain a complete sampling of IR probe signal energy ranging from 1-25 μm. The incident scanning angles of 0 may be optimized to maximize the IR radiation throughputs for both the internal reflection and transmission detection modes. Where two or more detectors are utilized, the radiation signals for each detector may be compared and the highest IR absorption peaks may be selected to represent the final IR absorption spectrum of sample being analyzed. Referring to FIG. 9, a plot illustrating a complete spectrum observed in accordance with aspects of the present disclosure is shown. It is noted that the spectrum illustrated in FIG. 9 was derived from the same thin dielectric film sample illustrated in the spectrum of FIG. 7, but was analyzed using an extended angle-dependent spectroscopic wafer characterization approach in accordance with the present disclosure. As shown in FIG. 9, by utilizing the extended angle-dependent wafer characterization method of the present disclosure, the previously obscured IR absorption peaks below 1500 cm⁻¹ on a silicon wafer become readily assessable for more in depth chemical bonding analysis. As illustrated in FIG. 10, the extended angle-dependent spectroscopic wafer characterization metrology can be implemented for the automatic whole wafer characterization and monitoring. The new chemical bonding transformation insights provided by performing whole wafer monitoring in accordance with the present disclosure may assist in monitoring and detecting defects in sampled substrates, further improve yield, reduce manufacturing costs, and shorten the product development cycle at each stage of advanced IC processing.

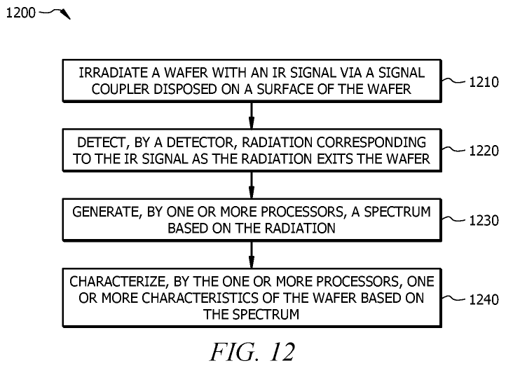

Referring to FIG. 12, a flow diagram illustrating an exemplary method for performing extended spectroscopic wafer characterization metrology is shown as a method 1200. In an aspect, the method 1200 may be performed by a system, such as the system 1100 of FIG. 11. Additionally, the steps of the method 1200 may be stored as instructions that, when executed by one or more processors, cause the one or more processors to perform the steps of the method 1200.

At step 1210, the method 1200 includes irradiating a wafer with an IR signal via a signal coupler disposed on a surface of the wafer. As described above and illustrated in FIGS. 3, 8, 10, and 11, the surface upon which the signal coupler is disposed may be different from one or more edge surfaces of the wafer. In an aspect, the IR signal may be provided by an IR signal generator, such as the IR signal source 1120 of FIG. 11, operating under the control or instruction of signals provided by a controller device, such as the computing device 1110 of FIG. 11.

At step 1220, the method 1200 includes detecting, by a detector, radiation corresponding to the IR signal as the radiation exits the wafer. At step 1230, the method 1200 includes generating, by one or more processors, a spectrum based on the radiation. In an aspect, the spectrum may be similar to the spectrum illustrated in FIG. 9, where IR absorption peaks below 1500 cm⁻¹ may be readily observed and used to characterize the wafer or sample. At step 1230, the method 1200 includes characterizing, by the one or more processors, one or more characteristics of the wafer based on the spectrum. As described above, embodiments may improve the characterization of a sample by enabling chemical bonding information and other information of interest (e.g., information identified by the IR absorption peaks below 1500 cm⁻¹). In an aspect, the information derived from the characterization of the sample may be utilized to modify or control one or more semiconductor manufacturing processes. The wafer characterization method 1200 may provide key chemical bonding transformation insights of the microfabrication process evolution to aid in new manufacturing techniques development and integration optimization. The disclosed embodiments can be applied to various aspects of front-end-of-line and back-end-of-line microfabrication processes including, but not limited to, advanced photolithography, photoresist formulation, dielectrics deposition/etching/cleaning, dielectrics damage control/repair, selective etching of dielectric films, post-etch residue removal, and etc. The method in 1200 can aid both in new manufacturing technology development and ensure QA/QC target as a microfabrication monitoring tool.

Although embodiments of the present application and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. Moreover, the scope of the present application is not intended to be limited to the particular embodiments of the process, machine, manufacture, composition of matter, means, methods and steps described in the specification.

1. A method for performing extended spectroscopic wafer characterization metrology, the method comprising:
irradiating a surface of a wafer with an IR signal, wherein the surface irradiated with the IR signal is different from one or more edge surfaces of the wafer;
detecting, by a detector, radiation corresponding to the IR signal as the radiation exits the wafer;
generating, by one or more processors, a spectrum based on the radiation; and
characterizing, by the one or more processors, one or more characteristics of the wafer based on the spectrum.

2. The method of claim 1, wherein the surface of the wafer irradiated by the IR signal comprises a signal coupler, and wherein the wafer is formed from a first material and the signal coupler comprises the first material.

3. The method of claim 2, wherein the radiation corresponding to the IR signal is detected as the radiation exits the wafer via a second signal coupler.

4. The method of claim 3, wherein the signal coupler and the second signal coupler are disposed on different surfaces of the wafer.

5. The method of claim 3, wherein the signal coupler and the second signal coupler are disposed on a same surface of the wafer.

6. The method of claim 1, wherein irradiating the surface of the wafer with the IR signal comprises providing the IR signal to the signal coupler at an angle.

7. The method of claim 1, further comprising:
irradiating one or more signal couplers disposed on the surface of the wafer with additional IR signals;
detecting, by one or more additional detectors, radiation corresponding to the one or more additional IR signals as additional radiation corresponding to the one or more additional IR signals exits the wafer;
generating, by the one or more processors, the spectrum based on the radiation and the additional radiation, wherein the one or more characteristics of the wafer are characterized based on the spectrum generated based on the radiation and the additional radiation.

8. The method of claim 1, further comprising:
irradiating an angled edge surface of the wafer with a second IR signal;
detecting, by a second detector, other radiation corresponding to the second IR signal;
generating, by the one or more processors, the spectrum based on the radiation and the other radiation, wherein the one or more characteristics of the wafer are characterized based on the spectrum generated based on the radiation and the other radiation.

9. The method of claim 8, wherein at least a first characteristic of the one or more characteristics of the wafer is characterized based on a first portion of the spectrum generated from the radiation and at least a second characteristic of the one or more characteristics of the wafer is characterized based on a second portion of the spectrum corresponding to the other radiation.

10. A system for performing extended spectroscopic wafer characterization metrology, the method comprising:
a signal coupler disposed on a surface of a wafer, wherein the surface upon which the signal coupler is disposed is different from one or more edge surfaces of the wafer;
an IR signal source configured to:
generate an IR signal; and
irradiate the wafer with the IR signal via the signal coupler;
a detector configured to detect radiation corresponding to the IR signal as the radiation exits the wafer; and
one or more processors configured to:
generate a spectrum based on the radiation; and
characterize one or more characteristics of the wafer based on the spectrum.

11. The system of claim 10, wherein the wafer is formed from a first material and the signal coupler comprises the first material.

12. The system of claim 10, further comprising a second signal coupler, wherein the detector is configured to detect the radiation corresponding to the IR signal as the radiation exits the wafer via the second signal coupler.

13. The system of claim 12, wherein the signal coupler and the second signal coupler are disposed on different surfaces of the wafer.

14. The system of claim 12, wherein the signal coupler and the second signal coupler are disposed on a same surface of the wafer.

15. The system of claim 10, wherein the IR signal source is configured to provide the IR signal to the signal coupler at an angle to irradiate the wafer with the IR signal.

16. The system of claim 10, further comprising:
one or more additional signal couplers disposed on at least one surface of the wafer; and
one or more additional detectors,
wherein the IR signal source is configured to irradiate the wafer with one or more additional IR signals via the one or more additional signal couplers,
wherein the one or more additional detectors are configured to detect additional radiation corresponding to the one or more additional IR signals as the additional radiation exits the wafer, and
wherein the one or more processors are configured to generate the spectrum based on the radiation and the additional radiation and to characterize the one or more characteristics of the wafer based on the spectrum generated from the radiation and the additional radiation.

17. The system of claim 10, further comprising:
a second detector configured to detect other radiation corresponding to a second IR signal,
wherein the wafer comprises an angled edge surface,
wherein the IR signal source is configured to irradiate the angled edge surface of the wafer with the second IR signal,
wherein the one or more processors are configured to generate the spectrum based on the radiation and the other radiation, and
wherein the one or more characteristics of the wafer are characterized based on the spectrum generated based on the radiation and the other radiation.

18. The system of claim 17, wherein at least a first characteristic of the one or more characteristics of the wafer is characterized based on a first portion of the spectrum generated from the radiation and at least a second characteristic of the one or more characteristics of the wafer is characterized based on a second portion of the spectrum corresponding to the other radiation.

19. A non-transitory computer-readable medium storing instructions that, when executed by one or more processors, cause the one or more processors to perform extended spectroscopic wafer characterization operations, the operations comprising:
controlling an IR signal source to irradiate a wafer with an IR signal via an input signal coupler disposed on a surface of the wafer, wherein the surface upon which the signal coupler is disposed is different from one or more edge surfaces of the wafer;
detecting radiation corresponding to the IR signal via a detector, wherein the radiation is detected by the detector as the radiation exits the wafer;
generating a spectrum based on the radiation; and
characterizing one or more characteristics of the wafer based on the spectrum.

20. The non-transitory computer-readable medium of claim 19, wherein the radiation corresponding to the IR signal is detected as the radiation exits the wafer via an output signal coupler, wherein the wafer is formed from a first material and the signal coupler and the output signal coupler comprise the first material.

21. The non-transitory computer-readable medium of claim 20, wherein the input signal coupler and the second signal coupler are disposed on different surfaces of the wafer.

22. The non-transitory computer-readable medium of claim 20, wherein the signal coupler and the second signal coupler are disposed on a same surface of the wafer.

23. The non-transitory computer-readable medium of claim 19, wherein the wafer is irradiated with the IR signal via the input coupler at an angle.

24. The non-transitory computer-readable medium of claim 19, the operations further comprising:
controlling the IR signal source to irradiate one or more additional input signal couplers disposed on the surface of the wafer with additional IR signals;
detecting additional radiation corresponding to the one or more additional IR signals via one or more additional detectors, wherein the additional radiation corresponding to the one or more additional IR signals exits the wafer via one or more additional output signal couplers;
generating, by the one or more processors, the spectrum based on the radiation and the additional radiation, wherein the one or more characteristics of the wafer are characterized based on the spectrum generated based on the radiation and the additional radiation.

25. The non-transitory computer-readable medium of claim 19, the operations further comprising:
controlling the IR signal source to irradiate an angled edge surface of the wafer with a second IR signal;
detecting other radiation corresponding to the second IR signal;
generating the spectrum based on the radiation and the other radiation, wherein the one or more characteristics of the wafer are characterized based on the spectrum generated based on the radiation and the other radiation.

26. The non-transitory computer-readable medium of claim 25, wherein at least a first characteristic of the one or more characteristics of the wafer is characterized based on a first portion of the spectrum generated from the radiation and at least a second characteristic of the one or more characteristics of the wafer is characterized based on a second portion of the spectrum corresponding to the other radiation.
